(19) United States
(12) Patent Application Publication
(10) Pub. No.: US 2012/0181174 A1
(43) Pub. Date: Jul. 19, 2012

(54) FUEL SENSOR

(75) Inventors: Masato UENO, Takahama-city (JP); Hiroshi Nakamura, Nishio-city (JP)

(73) Assignee: DENSO CORPORATION, Kariya-city (JP)

(21) Appl. No.: 13/292,355

(22) Filed: Nov. 9, 2011

(30) Foreign Application Priority Data
Jan. 13, 2011 (JP) 2011-4980

(51) Int. Cl. G01N 27/30

(52) U.S. Cl. 204/409

(57) ABSTRACT

A fuel sensor includes a passage forming unit, an outer electrode, an inner electrode, and a fuel characteristic detecting device. The passage forming unit defines a fuel passage and a receiving hole intersecting with the fuel passage perpendicularly. The outer electrode having a cylindrical shape is accommodated in the receiving hole, and includes first and second flow ports, which communicate with an inlet side part and an outlet side part of the fuel passage in a radial direction of the outer electrode respectively. The inner electrode is disposed radially inward of the outer electrode. The fuel characteristic detecting device detects an electrical characteristic of fuel flowing through an inner passage which is formed between the inner electrode and the outer electrode. Passage resistance against fuel is larger along an outer passage, which is formed between the outer electrode and the passage forming unit, than along the inner passage.

### CROSS REFERENCE TO RELATED APPLICATION

This application is based on and incorporates herein by reference Japanese Patent Application No. 2011-004980 filed on Jan. 13, 2011.

### BACKGROUND OF THE INVENTION

1. Field of the Invention

The present invention relates to a fuel sensor which detects a characteristic of fuel.

2. Description of Related Art

Conventionally, a fuel sensor, which is provided in a fuel supply system and detects fuel characteristics such as alcohol concentration of fuel, is known. The fuel supply system supplies fuel to an internal combustion engine. An alcohol concentration value detected by the fuel sensor is outputted to an electronic control unit (ECU) of the engine. The ECU controls a fuel injection amount and fuel injection timing depending on the alcohol concentration value. Accordingly, driving performance is improved and deterioration of exhaust gas is suppressed. A fuel sensor described in Patent Document 1 (JP-U-04-066571) includes an outer electrode and an inner electrode. The outer electrode has a cylindrical shape and defines a fuel passage. The inner electrode has a rod shape and is disposed on a radially inward of the outer electrode to be coaxial with the outer electrode. The fuel sensor described in Patent Document 1 detects an alcohol concentration value based on an electrostatic capacitance value of fuel flowing between the outer electrode and the inner electrode. A fuel sensor described in Patent Document 2 (JP-U-01-163862) includes an outer electrode and an inner electrode. The outer electrode has a cylindrical shape and is disposed in a fuel passage. The inner electrode is disposed inside the outer electrode to be coaxial with the outer electrode. An axis of the outer electrode is perpendicular to a flow direction of fuel flowing in a fuel passage, and the outer electrode has fuel flow ports, through which the fuel passes, on an upstream side and a downstream side of the outer electrode in the flow direction of fuel. The fuel sensor of Patent Document 2 detects an alcohol concentration value based on an electrostatic capacitance value of fuel which has passed through the fuel flow port and flowed between the outer electrode and the inner electrode.

In the fuel sensor described in Patent Document 1, in order to obtain a predetermined electrostatic capacitance value, axial lengths of the outer electrode and the inner electrode are set to be long. Therefore, when the alcohol concentration value of fuel changes, it takes a long time for the fuel in the outer electrode to be replaced. Accordingly, responsivity of alcohol-concentration detection may decrease. In the fuel sensor described in Patent Document 2, the fuel flow ports of the outer electrode are smaller than the fuel passage when viewed from an axial direction of the fuel passage. Thus, a fuel flow in the fuel passage is blocked by an outer wall of the outer electrode, and the fuel flow flows back or recirculates in the fuel passage. Accordingly, when the alcohol concentration value of fuel flowing in the fuel passage changes, the fuel before the change may flow into between the outer electrode and the inner electrode after a time lag. Therefore, it is concerned that output from the fuel sensor fluctuates and an error in measurement of alcohol concentration occurs.

### SUMMARY OF THE INVENTION

The present invention addresses at least one of the above disadvantages.

According to the present invention, there is provided a fuel sensor including a passage forming means, an outer electrode, an inner electrode, and a fuel characteristic detecting means. The passage forming means is for defining a fuel passage, through which fuel flows, and a receiving hole intersecting with the fuel passage generally perpendicularly. The outer electrode has a cylindrical shape and is accommodated in the receiving hole of the passage forming means. The outer electrode includes a first flow port communicating with an inlet side part of the fuel passage, and a second flow port communicating with an outlet side part of the fuel passage in a radial direction of the outer electrode. The inner electrode is accommodated in the receiving hole of the passage forming means and disposed radially inward of the outer electrode. The fuel characteristic detecting means is for detecting an electrical characteristic of fuel flowing through an inner passage which is formed between an inner wall of the outer electrode and an outer wall of the inner electrode. Passage resistance against fuel is larger along an outer passage, which is formed between an outer wall of the outer electrode and an inner wall of the passage forming means defining the receiving hole, than along the inner passage.

According to the present invention, there is also provided a fuel sensor including a passage forming means, an outer electrode, an inner electrode, and a fuel characteristic detecting means. The passage forming means is for defining a fuel passage, through which fuel flows, and a receiving hole intersecting with the fuel passage generally perpendicularly. The outer electrode has a cylindrical shape and is accommodated in the receiving hole of the passage forming means. The outer electrode includes a first flow port communicating with an inlet side part of the fuel passage and a second flow port communicating with an outlet side part of the fuel passage in a radial direction of the outer electrode. The inner electrode is accommodated in the receiving hole of the passage forming means and disposed radially inward of the outer electrode. The fuel characteristic detecting means is for detecting an electrical characteristic of fuel flowing through an inner passage which is formed between the outer electrode and the inner electrode. An inner wall of the first flow port and an inner wall of the second flow port of the outer electrode are located outward of an inner wall of the fuel passage of the passage forming means in the radial direction and an axial direction of the outer electrode to such an extent as to reduce pressure loss of fuel, which flows from the inlet side part to the outlet side part of the fuel passage through the inner passage.

### BRIEF DESCRIPTION OF THE DRAWINGS

The invention, together with additional objectives, features and advantages thereof, will be best understood from the following description, the appended claims and the accompanying drawings in which:

FIG. 1 is a sectional view showing a fuel sensor according to a first embodiment of the invention;

FIG. 2 is a schematic cross-sectional view taken along a line II-II of FIG. 1;

FIG. 3 is a sectional view taken along a line III-III of FIG. 2;

FIG. 4 is a sectional view taken along a line IV-IV of FIG. 2;

FIG. 5 is a cross-sectional view showing a fuel sensor according to a second embodiment of the invention;

FIG. 6 is a sectional view showing a fuel sensor according to a third embodiment of the invention;

FIG. 7 is a schematic cross-sectional view of a sectional plane taken along a line VII-VII of FIG. 6;

FIG. 8 is a sectional view taken along a line VIII-VIII of FIG. 7;

FIG. 9 is a sectional view taken along a line IX-IX of FIG. 7;

FIG. 10 is a characteristic diagram of the fuel sensor according to the third embodiment;

FIG. 11 is a cross-sectional view showing a main feature of a fuel sensor according to a first comparative example;

FIG. 12 is a sectional view showing a main feature of a fuel sensor according to a second comparative example; and

FIG. 13 is a characteristic diagram of the fuel sensor according to the second comparative example.

### DETAILED DESCRIPTION OF THE INVENTION

Embodiments of the invention will be described below with reference to the accompanying drawings.

### First Embodiment

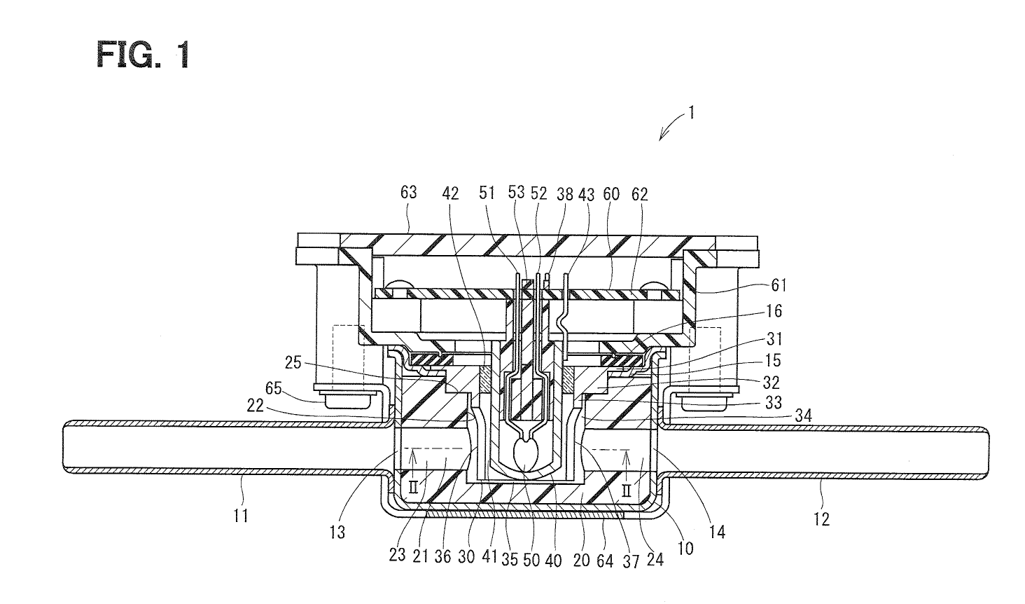

A fuel sensor according to a first embodiment of the invention is illustrated in FIGS. 1 to 4. The fuel sensor 1 of the present embodiment is provided in a fuel supply system which connects a fuel tank and a fuel injection device of a vehicle, and is a concentration sensor which detects alcohol concentration of fuel. An alcohol concentration value detected by the fuel sensor 1 is outputted to an electronic control unit (ECU) of an internal combustion engine. The ECU controls, for example, a fuel injection amount, fuel injection timing, and ignition timing depending on the alcohol concentration value. Accordingly, a fuel-air ratio of the engine is appropriate, so that driving performance of the vehicle can be improved. In addition, a noxious constituent in exhaust gas can be reduced.

As shown in FIG. 1, the fuel sensor 1 includes a fuel case 10, a passage forming means 20, an outer electrode 30, an inner electrode 40, a thermistor 50, and a detection circuit 60, which serves as a fuel characteristic detecting means. The fuel case 10 has a cylindrical shape having a bottom and is made of metal such as stainless steel. An outer wall of the fuel case 10 on its one side in a radial direction of the fuel case 10 is connected to an inlet pipe 11, and the outer wall of the fuel case 10 on the other side in the radial direction is connected to an outlet pipe 12. The inlet pipe 11 and the outlet pipe 12 have a cylindrical shape and are made of metal such as stainless steel. The inlet pipe 11 and the outlet pipe 12 are fixed on the outer wall of the fuel case 10 by welding, for example. An inlet opening 13 is formed at a position of the fuel case 10 connected with the inlet pipe 11, and an outlet opening 14 is formed at a position of the fuel case 10 connected with the outlet pipe 12.

Inside the fuel case 10, the passage forming means 20 is provided and is made of, for example, resin or stainless steel. The passage forming means 20 includes a fuel passage 21 and a receiving hole 22. One side of the fuel passage 21 in an axial direction thereof communicates with the inlet opening 13 of the fuel case 10, and the other side of the fuel passage 21 in the axial direction communicates with the outlet opening 14 of the fuel case 10. Accordingly, fuel flows from the inlet pipe 11 through the fuel passage 21 of the passage forming means 20 into the outlet pipe 12. The receiving hole 22 is provided to intersect with the fuel passage 21 almost perpendicularly and has a cylindrical shape. An end of the receiving hole 22 opens on an outer wall of the passage forming means 20. An inner diameter of the receiving hole 22 is larger than an inner diameter of the fuel passage 21. Hereinafter, the fuel passage 21 on a fuel inlet side of the receiving hole 22 is referred to as an upstream passage (inlet side part) 23, and the fuel passage 21 on a fuel outlet side of the receiving hole 22 is referred to as a downstream passage (outlet side part) 24. In an opening of the fuel case 10, a lid member 15 is provided to be in abutment with an upper part of the passage forming means 20.

The outer electrode 30 has a cylindrical shape and is made of metal such as stainless steel. The outer electrode 30 is accommodated by the receiving hole 22. The outer electrode 30 is nearly coaxial with the receiving hole 22. The outer electrode 30 includes a flange 31, a thick part 32, and an electrode body 33. The flange 31 has an annular shape and extends radially outward from one side of the outer electrode 30 in an axial direction of the outer electrode 30. The thick part 32 is located under the flange 31. The electrode body 33 is located under the thick part 32. The flange 31 is engaged with the lid part 15. The thick part 32 is in abutment with a step difference 25 of the passage forming means 20. An outer diameter of the electrode body 33 of the outer electrode 30 is smaller than the inner diameter of the receiving hole 22. Accordingly, an outer passage 34, through which fuel flows, is defined between an inner wall of the receiving hole 22 and the electrode body 33. Moreover, a bottom passage 35, through which fuel flows, is defined between an end surface of the outer electrode 30 located on its opposite side from the flange 31 and a bottom of the receiving hole 22.

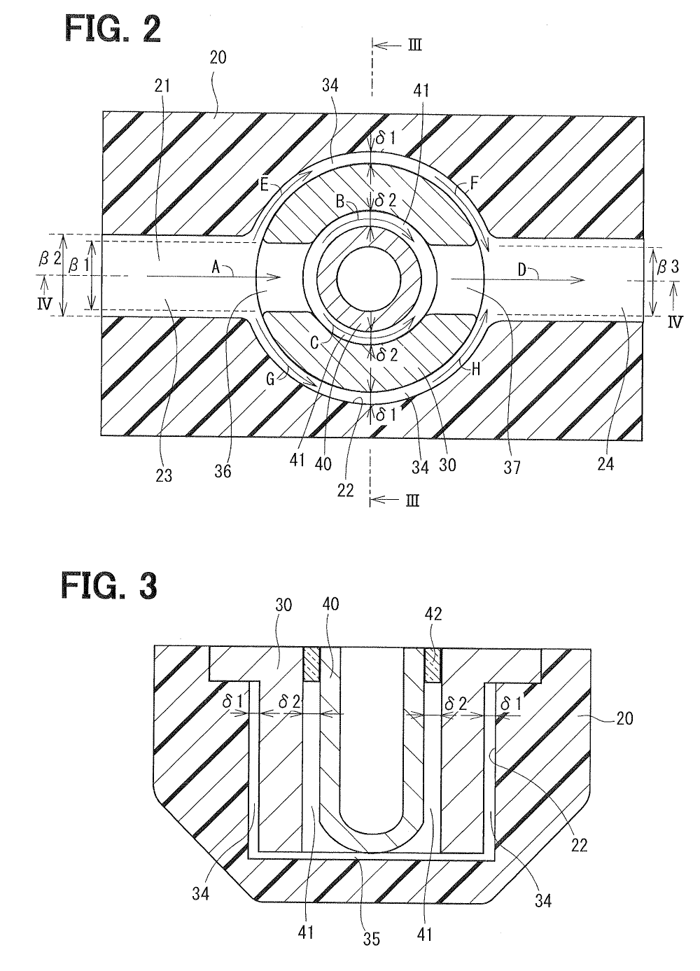

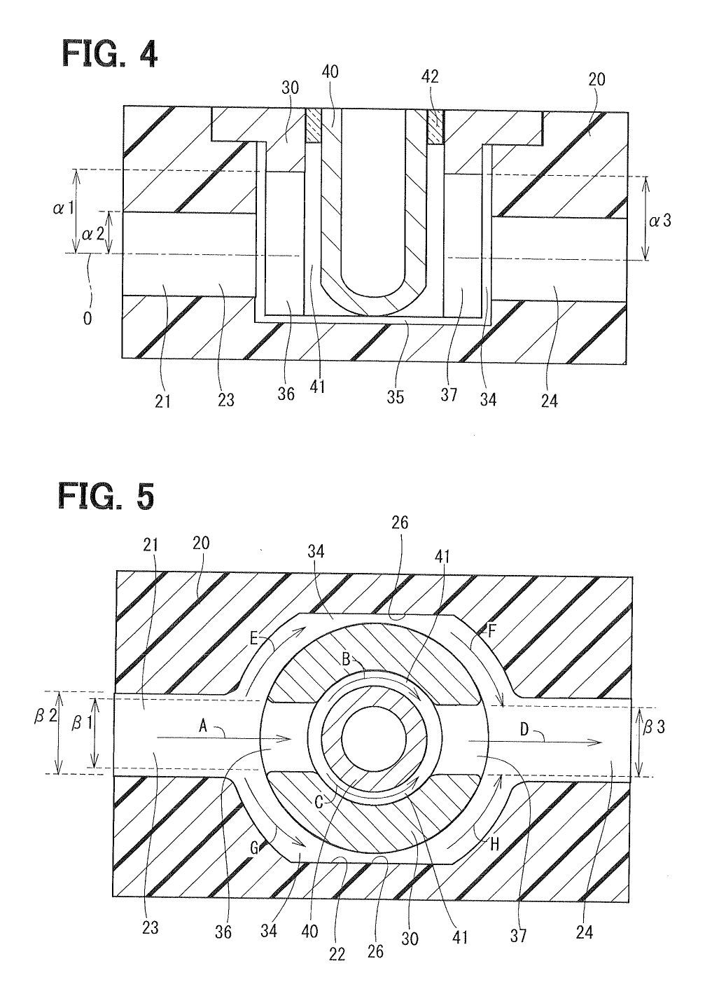

The outer electrode 30 further includes a first flow port 36 which communicates with the upstream passage 23, and a second flow port 37 which communicates with the downstream passage 24. The first flow port 36 and the second flow port 37 have a U-shape which opens on an end portion of the outer electrode 30 on the bottom passage 35-side in the axial direction of the outer electrode 30. As shown in FIG. 4, an inner wall of the first flow port 36 is located outward of an inner wall of the fuel passage 21 in the axial direction of the outer electrode 30. An inner wall of the second flow port 37 is located outward of the inner wall of the fuel passage 21 in the axial direction of the outer electrode 30. Specifically, in the axial direction of the outer electrode 30, a distance α1 between the inner wall of the first flow port 36 and a center axis O of the fuel passage 21 is longer than a distance α2 between the inner wall of the fuel passage 21 and the center axis O. A distance α3 between the inner wall of the second flow port 37 and the center axis O of the fuel passage 21 is longer than the distance α2 between the inner wall of the fuel passage 21 and the center axis O. Therefore, fluid resistance of the fuel flowing from the upstream passage 23 to an inner passage 41 is reduced. The inner passage 41, which is described in greater detail hereinafter, is defined between the outer electrode 30 and the inner electrode 40. Fluid resistance of fuel flowing from the inner passage 41 to the downstream passage 24 is also reduced. As shown in FIG. 2, the inner wall of the first flow port 36 is located inward of the inner wall of the fuel passage 21 in the radial direction of the outer electrode 30. The inner wall of the second flow port 37 is located inward of the inner wall of the fuel passage 21 in the radial direction of the outer electrode 30. Specifically, a width β1 of the first flow port 36 in the radial direction of the outer electrode 30 is smaller than the inner diameter β2 of the fuel passage 21. A width β3 of the second flow port 37 in the radial direction of the outer electrode 30 is smaller than the inner diameter β2of the fuel passage 21. Accordingly, the fuel flowing from the upstream passage 23 into the outer passage 34 increases in quantity, and fuel pressure in the outer passage 34 is raised.

As shown in FIG. 1, the inner electrode 40 has a cylindrical shape and is made of metal such as stainless steel. The inner electrode 40 is disposed radially inward of the outer electrode 30. The inner electrode 40 is nearly coaxial with the receiving hole 22 and the outer electrode 30. An outer wall surface of a bottom part of the inner electrode 40 has a curved surface projecting toward the bottom of the receiving hole 22. An outer diameter of the inner electrode 40 is smaller than an inner diameter of the outer electrode 30. Hence, the inner passage 41, through which fuel flows, is defined between the inner electrode 40 and the outer electrode 30. An insulator 42 made of glass is provided between the inner electrode 40 and the outer electrode 30. The inner electrode 40 is fixed hermetically to the outer electrode 30 through the insulator 42, which electrically insulates the inner electrode 40 from the outer electrode 30.

Inside the inner electrode 40, the thermistor 50 serving as a temperature detecting means is provided. Terminals 51 and 52 of the thermistor 50 are supported by a support 53 made of resin. The heat of fuel flowing in the inner passage 41 is transferred to the thermistor 50 through the inner electrode 40. The thermistor 50 changes its electrical resistance depending on a temperature change of fuel. The temperature of fuel flowing in the inner passage 41 can be detected by the thermistor 50.

An annular elastic member 16 is disposed on an upper side of the lid member 15 in an axial direction of the fuel case 10. Above the elastic member 16, a circuit case 61 is disposed. The elastic member 16 prevents a fuel leakage from between the lid member 15 and the circuit case 61. The circuit case 61 is made of resin, for example, and contains a circuit board 62. The detection circuit 60 serving as the fuel characteristic detecting means for detecting an electrical characteristic of the fuel flowing in the inner passage 41 is disposed on the circuit board 62. The detection circuit 60 is connected to a terminal 38 connecting to the outer electrode 30, a terminal 43 connecting to the inner electrode 40, and the terminals 52 and 52 of the thermistor 50. The detection circuit 60 detects an electrostatic capacitance value between the outer electrode 30 and the inner electrode 40 by charge and discharge of electricity between the outer electrode 30 and the inner electrode 40. The electrostatic capacitance value changes depending on permittivity of fuel. The permittivity changes depending on a fuel temperature and a mixture ratio of gasoline and alcohol in fuel. Accordingly, the detection circuit 60 detects an alcohol concentration value of fuel flowing in the inner passage 41 based on both the electrostatic capacitance value between the electrodes and the fuel temperature detected by the thermistor 50. An opening of the circuit case 61 is covered by a plate-like cover 63. The cover 63 prevents water or the like from entering into the circuit case 61. The fuel case 10 is supported by a bracket 64 from outside the fuel case 10. The bracket 64 is attached to the circuit case 61 by a screw 65. Hence, the fuel case 10 and the circuit case 61 are fixed to each other.

A fuel stream through the passages of the fuel sensor 1 according to the present embodiment will be described referring to FIG. 2. In the present embodiment, the receiving hole 22 of the passage forming means 20, outer and inner walls of the outer electrode 30, and an outer wall of the inner electrode 40 have a round shape and are almost concentric with each other in cross-sectional view in FIG. 2. A distance δ1 between the inner wall of the passage forming means 20 defining the receiving hole 22 and the outer wall of the outer electrode 30 is equal to or smaller than a distance δ2 between the inner wall of the outer electrode 30 and the outer wall of the inner electrode 40. Because the outer passage 34 is longer than the inner passage 41, a wall surface length as a resistance component is longer along the outer passage 34 than along the inner passage 41. Thus, if a width of the outer passage 34 is equal to or smaller than a width of the inner passage 41, fluid resistance is larger in the outer passage 34 than in the inner passage 41. Accordingly, as arrows A to D indicate in FIG. 2, in the present embodiment, the fuel stream from the upstream passage 23 through the first flow port 36, the inner passage 41, and the second flow port 37 to the downstream passage 24 is a main stream. Moreover, as arrows E to H indicate, a part of the fuel stream from the upstream passage 23 to the downstream 24 passes through the outer passage 34. A speed of the fuel stream through the first flow port 36, the inner passage 41, and the second flow port 37 is higher than a speed of the fuel stream through the outer passage 34. Because the inner wall of the first flow port 36 is located inward of the inner wall of the upstream passage 23 in the radial direction of the outer electrode 30, the fuel flowing into the outer passage 34 from the upstream passage 23 increases in quantity. Hence, the fuel stream through the first flow port 36, the inner passage 41, and the second flow port 37 flows into the downstream passage 24 without flowing back toward the outer passage 34.

A fuel stream in a fuel sensor according to a first comparative example will be described referring to FIG. 11. In the first comparative example, elements corresponding to those described in the first embodiment are assigned numerals, each last of which includes 0 (zero) in addition to its counterpart numeral, and the description of these elements will be omitted. In the first comparative example, a distance δ3 between an inner wall of a passage forming means 200 defining a receiving hole 220 and an outer wall of an outer electrode 300 is longer than a distance δ4 between an inner wall of the outer electrode 300 and an outer wall of an inner electrode 400. Thus, a width of an outer passage 340 in a radial direction of the outer electrode 300 is larger than a width of an inner passage 410 in the radial direction of the outer electrode 300. Therefore, fluid resistance is smaller along the outer passage 340 than along the inner passage 410. In this case, a pressure of fuel flowing in the outer passage 340 is smaller than a pressure of the fuel flowing from a second flow port 370 through the inner passage 410. Hence, a part of the fuel stream through a first flow port 360, the inner passage 410, and the second flow port 370, which is indicated by arrows I to L in FIG. 11, flows back toward the outer passage 340 as arrows M to Q indicate. When an alcohol concentration value of the fuel flowing in a fuel passage 210 changes, it is possible that the fuel flowing out from the second flow port 370 passes through the outer passage 340 and flows again into the inner passage 410 from the first flow port 360. Then, output from a detection circuit 600 may fluctuate. Accordingly, it is concerned that an error in measurement of alcohol concentration occurs.

An operation and effect of the fuel sensor 1 according to the first embodiment will be described. In the embodiment, because the outer passage 34 is longer than the inner passage 41, the wall surface length as the resistance component is longer along the outer passage 34 then along the inner passage 41. Furthermore, the width of the outer passage 34 in the radial direction of the outer electrode 30 is equal to or smaller than the width of the inner passage 41 in the radial direction of the outer electrode 30. Therefore, the fluid resistance is higher along the outer passage 34 than along the inner passage 41. Thus, a back-flow of fuel, which has flowed out of the second flow port 37 through the inner passage 41, toward the outer passage 34 is limited. Hence, when the alcohol concentration value of fuel flowing in the fuel passage 21 changes, the electrical characteristic of fuel flowing in the inner passage 41 also changes depending on the alcohol concentration change, so that fluctuation of output from the detection circuit 60 is suppressed. Accordingly, in the fuel sensor 1, measurement accuracy of the alcohol concentration can be improved.

In the present embodiment, as illustrated in FIG. 4, the inner wall of the first flow port 36 and the inner wall of the second flow port 37 are located outward of the inner wall of the fuel passage 21 in the axial direction of the outer electrode 30. Hence, pressure loss of the fuel flowing from the upstream passage 23 through the inner passage 41 to the downstream passage 24 is suppressed. Moreover, because the fuel in the inner passage 41 promptly exchanges, responsivity of detection of the alcohol concentration by the fuel sensor 1 can be enhanced.

Furthermore, in the present embodiment, bottom parts of the first flow port 36 and the second flow port 37 opens on the end portion of the outer electrode 30. Thus, the pressure loss of fuel flowing from the upstream passage 23 through the inner passage 41 to the downstream passage 24 is suppressed. Moreover, because fuel in the inner passage 41 promptly exchanges, the responsivity of the detection of the alcohol concentration by the fuel sensor 1 can be improved.

### Second Embodiment

A fuel sensor according to a second embodiment of the invention is illustrated in FIG. 5. In follow embodiments, the substantially same parts as the above-described first embodiment are assigned their corresponding numerals and the description of these parts will be omitted. In the present embodiment, a passage forming means 20 has a flat part 26 on an inner wall of its receiving hole 22. The flat part 26 extends parallel to an axial direction of an outer electrode 30. Thus, regions having narrow passage width are formed along the outer passage 34 between an inlet and an outlet thereof. Therefore, fluid resistance is higher along the outer passage 34 than along the inner passage 41. Hence, the fuel stream through the first flow port 36, the inner passage 41, and the second flow port 37 flows into the downstream passage 24 without flowing back into the outer passage 34. As a result, the present embodiment can produce effects similar to the above-described first embodiment. The flat part 26 may be disposed separately from the passage forming means 20.

### Third Embodiment

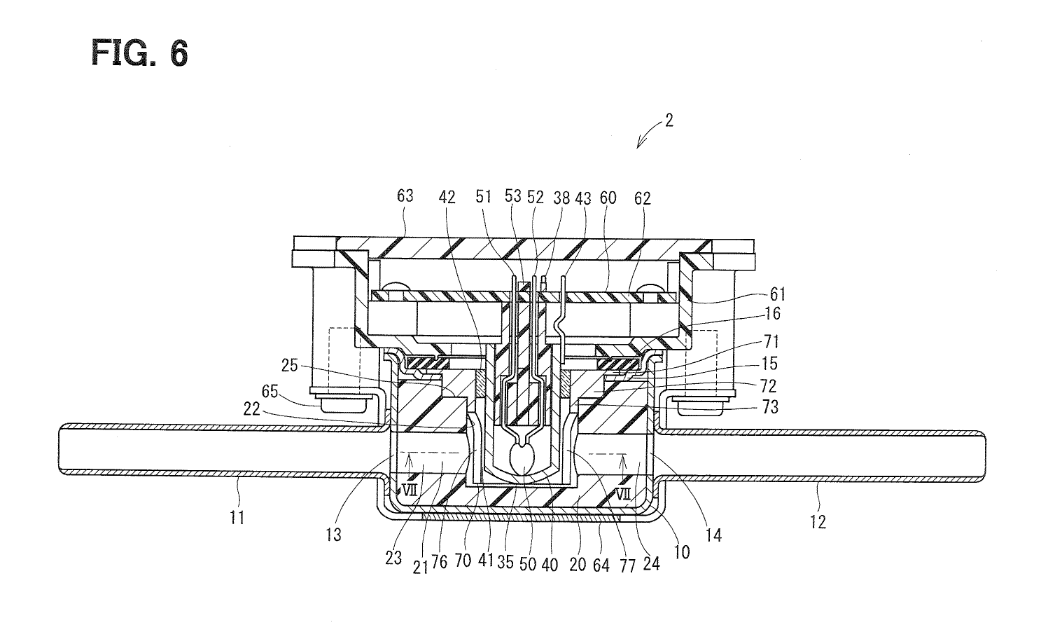

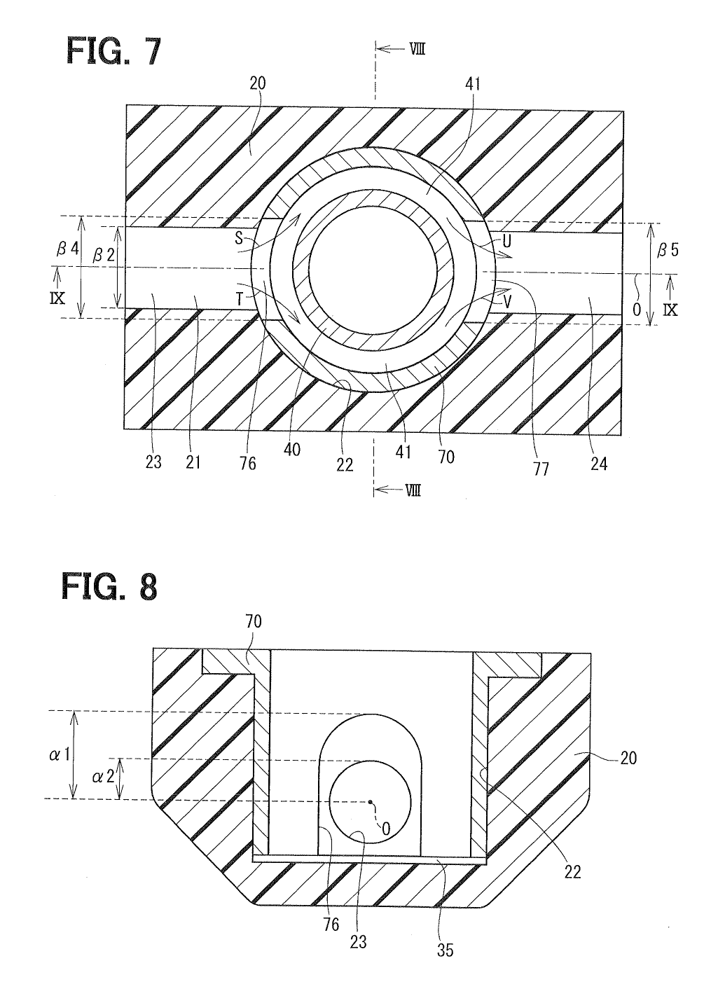

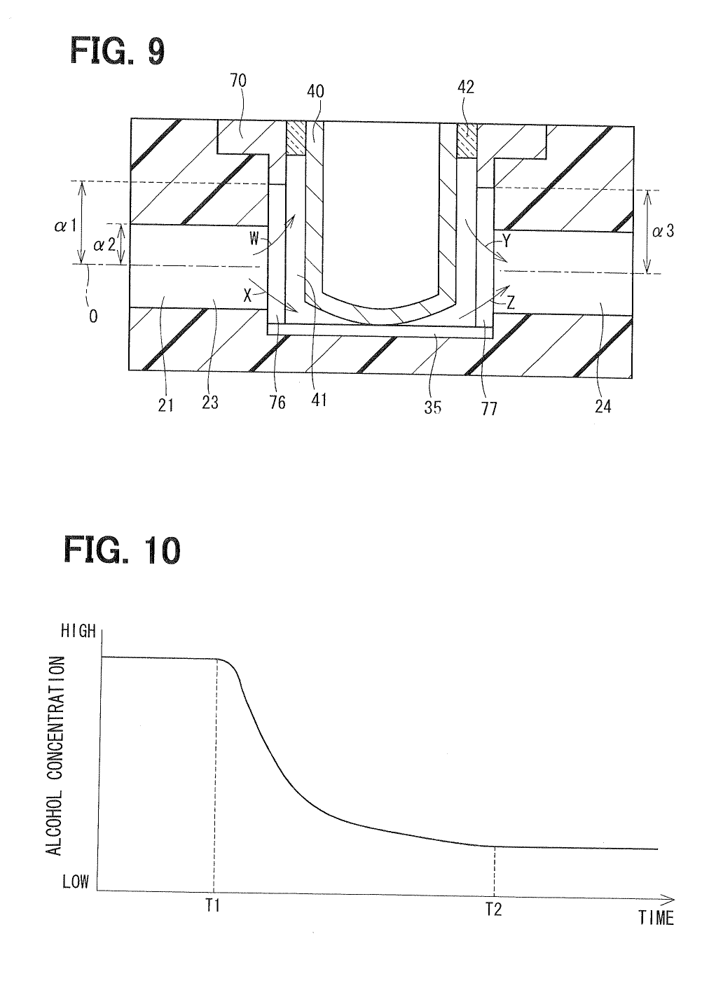

A fuel sensor 2 according to a third embodiment of the invention is illustrated in FIGS. 6 to 10. In the present embodiment, an inner diameter of a receiving hole 22 of a passage forming means 20 is almost the same as an outer diameter of an electrode body 73 of an outer electrode 70. Thus, an outer passage is not defined between an inner wall of the receiving hole 22 and the outer electrode 70. As shown in FIG. 7, an inner wall of a first flow port 76 is located outward of an inner wall of a fuel passage 21 in a radial direction of the outer electrode 70. An inner wall of a second flow port 77 is located outward of the inner wall of the fuel passage 21 in the radial direction of the outer electrode 70. Specifically, a width β4 of the first flow port 76 in the radial direction of the outer electrode 70 is larger than an inner diameter β2 of the fuel passage 21. A width β5 of the second flow port 77 in the radial direction of the outer electrode 70 is larger than the inner diameter 132 of the fuel passage 21. Hence, as arrows S and T indicate in FIG. 7, fluid resistance of the fuel flowing from an upstream passage 23 to an inner passage 41 is reduced. As arrows U and T indicate, fluid resistance of the fuel flowing from the inner passage 41 to a downstream passage 24 is also reduced. As shown in FIG. 8, the inner wall of the first flow port 76 is located outward of the inner wall of the fuel passage 21 in an axial direction of the outer electrode 70. In FIG. 8, an illustration of an inner electrode 40 is omitted. As shown in FIG. 9, the inner wall of the second flow port 77 is located outward of the inner wall of the fuel passage 21 in the axial direction of the outer electrode 70. Therefore, as arrows W and X indicate in FIG. 9, fluid resistance of the fuel flowing from the upstream passage 23 to the inner passage 41 is reduced. As arrows Y and Z indicate, fluid resistance of the fuel flowing from the inner passage 41 to the downstream passage 24 is also reduced.

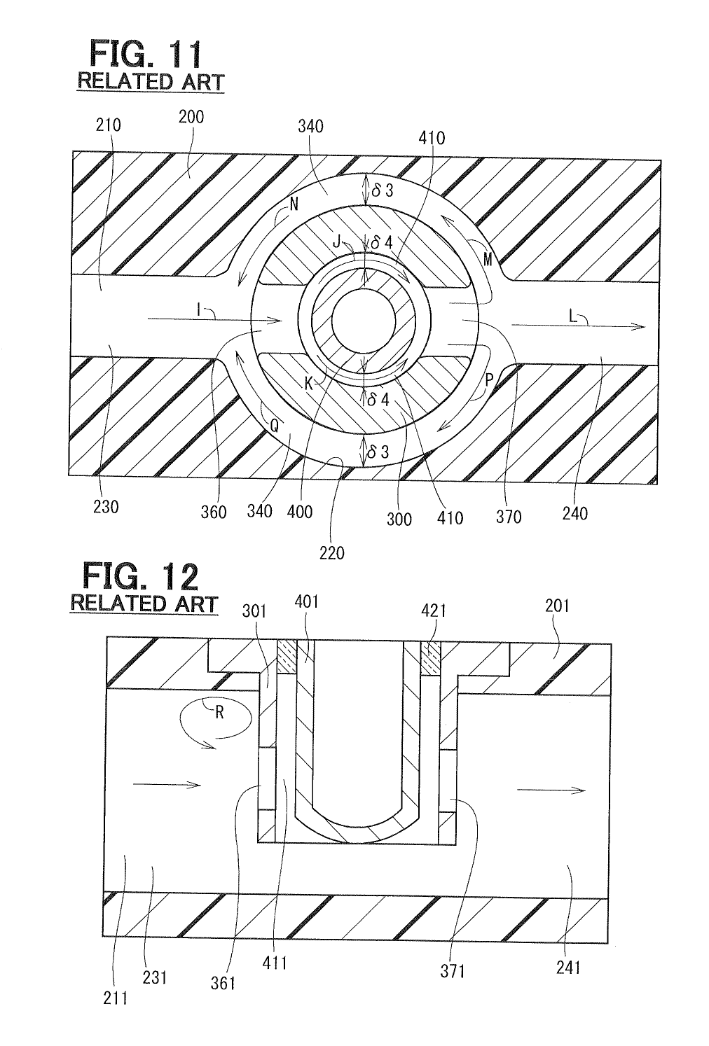

Output characteristic of the fuel sensor 2 according to the present embodiment is shown in FIG. 10. FIG. 10 shows the output characteristic of the fuel sensor 2 when an alcohol concentration value of the fuel flowing in the fuel passage 21 changes from a higher to lower state. In the fuel sensor 2 of the present embodiment, output, which indicates the alcohol concentration, gradually decreases in accordance with the change of the alcohol concentration value of the fuel between times T1 and T2.

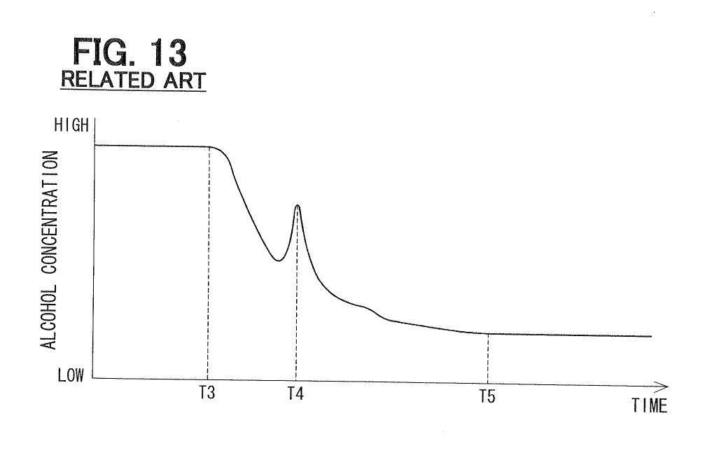

A fuel sensor according to a second comparative example is illustrated in FIG. 12, and output characteristic of the fuel sensor is shown in FIG. 13. In the second comparative example, elements corresponding to those described in the first embodiment are assigned numerals, each last number of which includes 1 in addition to its counterpart numeral, and the description of those elements will be omitted. In the second comparative example, a first flow port 361 and a second flow port 371 have a round shape when viewed from an axial direction of a fuel passage 211. Inner wall surfaces of the first flow port 361 and the second flow port 371 are located inward of an inner wall surface of the fuel passage 211 in a radial direction of the fuel passage 211. Thus, a fuel stream through an upstream passage 231 is blocked by an outer wall of an outer electrode 301. As an arrow R indicates in FIG. 12, the fuel stream flows back along the fuel passage 211 or recirculates in the fuel passage 211. Accordingly, when an alcohol concentration value of the fuel changes, the fuel before the change flows into an inner passage 411 after a time lag.

Output characteristic of the fuel sensor of the second comparative example is shown in FIG. 13. In FIG. 13, between time T3 and time T5, the alcohol concentration value of the fuel stream through the fuel passage 211 changes from a higher to lower state. In the fuel sensor of the second comparative example, because the fuel before the change flows into the inner passage 411 after a time lag, output indicating the alcohol concentration is high at time T4. It is concerned that an error in measurement of the alcohol concentration occurs due to this output fluctuation.

An operation and effect of the fuel sensor 2 according to the third embodiment will be described. In the present embodiment, the fuel stream through the upstream passage 23 promptly flows into the inner passage 41 from the first flow port 76 without blocking by the outer wall of the outer electrode 70. Hence, when the alcohol concentration value of the fuel changes, a delayed flow of the fuel before the change into the inner passage 41 is limited. Therefore, occurrence of output fluctuation in the fuel sensor 2 can be suppressed, and detection accuracy of the alcohol concentration can be enhanced. Moreover, in the present embodiment, the inner walls of the first flow port 76 and the second flow port 77 are located outward of the inner wall of the fuel passage 21 in a radial direction of the outer electrode 70. Thus, pressure loss of the fuel stream from the upstream passage 23 to the downstream passage 24 is reduced. Because the fuel in the inner passage 41 can be promptly exchanged, responsivity of alcohol-concentration detection by the fuel sensor 2 can be improved.

Modification of the above embodiments will be described. In the above-described embodiments, the fuel case 10, the passage forming means 20, the inlet pipe 11, and the outlet pipe 12 are separately provided. However, in the invention, these components may be integrally provided with each other. In the above-described embodiments, as the fuel sensor, the concentration sensor, which detects an alcohol concentration value of fuel based on an electrical characteristic between the electrodes, is described. However, in the invention, for example, a fuel sensor, which detects an oxidation-degradation state of fuel based on the electrical characteristic between the electrodes, may be used. In the fuel sensor of the above-described embodiments, by detecting an electrostatic capacitance value between the electrodes, a characteristic and a state of the fuel are detected based on permittivity of the fuel. However, by detecting a resistance value between the electrodes, the fuel sensor of the invention may detect the characteristic and the state of the fuel based on the permittivity of the fuel. The invention is not limited to the above-described embodiments, and may be embodied in various modes without departing from the scope of the invention.

To sum up, the fuel sensor 1 in accordance with the above embodiments may be described as follows.

The fuel sensor 1 includes the passage forming means 20, the outer electrode 30, the inner electrode 40, and the fuel characteristic detecting means 60. The passage forming means 20 defines the fuel passage 21, through which fuel flows, and the receiving hole 22 intersecting with the fuel passage 21 generally perpendicularly. The outer electrode 30 has a cylindrical shape and is accommodated in the receiving hole 22 of the passage forming means 20. The outer electrode 30 includes the first flow port 36 communicating with the inlet side part 23 of the fuel passage 21, and the second flow port 37 communicating with the outlet side part 24 of the fuel passage 21 in the radial direction of the outer electrode 30. The inner electrode 40 is accommodated in the receiving hole 22 of and disposed radially inward of the outer electrode 30. The fuel characteristic detecting means 60 detects an electrical characteristic of fuel flowing through the inner passage 41 which is formed between the inner wall of the outer electrode 30 and the outer wall of the inner electrode 40. Passage resistance against fuel is larger along the outer passage 34, which is formed between the outer wall of the outer electrode 30 and the inner wall of the passage forming means 20 defining the receiving hole 22, than along the inner passage 41. Accordingly, it is suppressed that fuel flowing from the inlet side part 23 to the outlet side part 24 through the inner passage 41 flows back toward the outer passage 34. Thus, when characteristics of fuel flowing through the fuel passage 21 change, an electrical characteristic of fuel flowing through the inner passage 41 promptly changes in accordance with the change of fuel characteristics. Hence, output fluctuation of the fuel sensor 1 is limited. As a result, accuracy of fuel characteristic detection by the fuel sensor 1 can be improved.

The receiving hole 22 of the passage forming means 20, the inner and outer walls of the outer electrode 30, and the outer wall of the inner electrode 40 have round shapes in cross-section and may be generally coaxial with each other. The distance δ1 between the outer wall of the outer electrode 30 and the inner wall of the passage forming means 20 defining the receiving hole 22 may be equal to or smaller than a distance δ2 between the outer wall of the inner electrode 40 and the inner wall of the outer electrode 30. Because the outer passage 34 is longer than the inner passage 41, the wall surface length as a resistance component is longer along the outer passage 34 than along the inner passage 41. Hence, if the passage width of the outer passage 34 is equal to or smaller than that of the inner passage 41, passage resistance against fuel is larger along the outer passage 34 than along the inner passage 41. Therefore, it is suppressed that fuel flowing from the inlet side part 23 to the outlet side part 24 of the fuel passage 21 through the inner passage 41 flows back toward the outer passage 34.

The inner wall of the first flow port 36 of the outer electrode 30 may be located outward of the inner wall of the fuel passage 21 of the passage forming means 20 in the axial direction of the outer electrode 30. Fuel flowing from the inlet side part 23 of the fuel passage 21 toward the inner passage 41 through the first fuel port 36 promptly flows into the inner passage 41 without blocking by the wall of the outer electrode 30. Thus, output fluctuation of the fuel sensor 1 is limited, and accuracy of fuel characteristic detection can be improved. Moreover, fluid resistance of fuel, which flows from the inlet side part 23 of the fuel passage 21 toward the inner passage 41 through the first fuel port 36, is reduced, and pressure loss of the fuel flow decreases. Hence, because fuel promptly flows through the inner passage 41, responsivity of the fuel characteristic detection can be enhanced.

The inner wall of the second flow port 37 of the outer electrode 30 may be located outward of the inner wall of the fuel passage 21 of the passage forming means 20 in the axial direction of the outer electrode 30. Accordingly, fluid resistance of fuel, which flows from the inner passage 41 toward the outlet side part 24 of the fuel passage 21 through the second fuel port 37, is reduced, and pressure loss of the fuel flow decreases. Hence, because fuel promptly flows through the inner passage 41, responsivity of fuel characteristic detection can be enhanced.

The inner wall of the first flow port 36 of the outer electrode 30 may be located inward of the inner wall of the fuel passage 21 of the passage forming means 20 in the radial direction of the outer electrode 30. Accordingly, quantity of fuel flowing from the inlet side part 23 of the fuel passage 21 into the outer passage 34 increases. Thus, pressure of fuel flowing through the outer passage 34 can be raised more than pressure of fuel flowing through the inner passage 41.

The inner wall of the first flow port 36 of the outer electrode 30 may be located outward of the inner wall of the fuel passage 21 of the passage forming means 20 in the radial direction of the outer electrode 30. Accordingly, fluid resistance of fuel, which flows from the inlet side part 23 of the fuel passage 21 toward the inner passage 41 through the first fuel port 36, is reduced, and pressure loss of the fuel flow decreases.

The outer electrode 30 and the bottom of the receiving hole 22 in a vertical direction thereof may define a bottom passage 35, through which fuel flows, between the outer electrode 30 and the receiving hole 22. Bottom passage 35-side portions of the first flow port 36 and the second flow port 37 open on an end part of the outer electrode 30 in the axial direction thereof. Accordingly, fluid resistance of fuel, which flows from the inlet side part 23 toward the outlet side part 24 of the fuel passage 21 through the bottom passage 35, is reduced. Therefore, because fuel flowing through the inner passage 41 is promptly replaced without being interrupted, responsivity of fuel characteristic detection can be improved.

The inner wall of the first flow port 76 and the inner wall of the second flow port 77 of the outer electrode 70 may be located outward of the inner wall of the fuel passage 21 of the passage forming means 20 in the radial direction and the axial direction of the outer electrode 70 to such an extent as to reduce pressure loss of fuel, which flows from the inlet side part 23 to the outlet side part 24 of the fuel passage 21 through the inner passage 41. Accordingly, fuel flowing from the inlet side part 23 to the outlet side part 24 through the inner passage 41 promptly flows into the inner passage 41 from the inlet side part 23 through the first fuel port 76 and flows out from the inner passage 41 into the outlet side part 24 through the second fuel port 77 without blocking by the wall of the outer electrode 70. Thus, when characteristics of fuel flowing through the fuel passage 21 change, an electrical characteristic of fuel flowing through the inner passage 41 promptly changes in accordance with the change of fuel characteristics. Hence, output fluctuation of the fuel sensor 1 is limited. Therefore, accuracy of fuel characteristic detection by the fuel sensor 1 can be improved. Moreover, because fuel flowing through the inner passage 41 is promptly replaced without being interrupted, responsivity of the fuel characteristic detection can be enhanced.

Additional advantages and modifications will readily occur to those skilled in the art. The invention in its broader terms is therefore not limited to the specific details, representative apparatus, and illustrative examples shown and described.

What is claimed is:

1. A fuel sensor comprising:
a passage forming means for defining a fuel passage, through which fuel flows, and a receiving hole intersecting with the fuel passage generally perpendicularly;
an outer electrode having a cylindrical shape and accommodated in the receiving hole of the passage forming means, wherein the outer electrode includes a first flow port communicating with an inlet side part of the fuel passage, and a second flow port communicating with an outlet side part of the fuel passage in a radial direction of the outer electrode;
an inner electrode accommodated in the receiving hole of the passage forming means and disposed radially inward of the outer electrode; and
a fuel characteristic detecting means for detecting an electrical characteristic of fuel flowing through an inner passage which is formed between an inner wall of the outer electrode and an outer wall of the inner electrode, wherein passage resistance against fuel is larger along an outer passage, which is formed between an outer wall of the outer electrode and an inner wall of the passage forming means defining the receiving hole, than along the inner passage.

2. The fuel sensor according to claim 1, wherein:
the receiving hole of the passage forming means, the inner and outer walls of the outer electrode, and the outer wall of the inner electrode have round shapes in cross-section and are generally coaxial with each other; and
a distance between the outer wall of the outer electrode and the inner wall of the passage forming means defining the receiving hole is equal to or smaller than a distance between the outer wall of the inner electrode and the inner wall of the outer electrode.

3. The fuel sensor according to claim 1, wherein an inner wall of the first flow port of the outer electrode is located outward of an inner wall of the fuel passage of the passage forming means in an axial direction of the outer electrode.

4. The fuel sensor according to claim 1, wherein an inner wall of the second flow port of the outer electrode is located outward of an inner wall of the fuel passage of the passage forming means in an axial direction of the outer electrode.

5. The fuel sensor according to claim 1, wherein an inner wall of the first flow port of the outer electrode is located inward of an inner wall of the fuel passage of the passage forming means in the radial direction of the outer electrode.

6. The fuel sensor according to claim 1, wherein an inner wall of the first flow port of the outer electrode is located outward of an inner wall of the fuel passage of the passage forming means in the radial direction of the outer electrode.

7. The fuel sensor according to claim 1, wherein:
the outer electrode and a bottom of the receiving hole in a vertical direction thereof define a bottom passage, through which fuel flows, between the outer electrode and the receiving hole; and
bottom passage-side portions of the first flow port and the second flow port open on an end part of the outer electrode in an axial direction thereof.

8. A fuel sensor comprising:
a passage forming means for defining a fuel passage, through which fuel flows, and a receiving hole intersecting with the fuel passage generally perpendicularly;
an outer electrode having a cylindrical shape and accommodated in the receiving hole of the passage forming means, wherein the outer electrode includes a first flow port communicating with an inlet side part of the fuel passage and a second flow port communicating with an outlet side part of the fuel passage in a radial direction of the outer electrode;
an inner electrode accommodated in the receiving hole of the passage forming means and disposed radially inward of the outer electrode; and
a fuel characteristic detecting means for detecting an electrical characteristic of fuel flowing through an inner passage which is formed between the outer electrode and the inner electrode, wherein an inner wall of the first flow port and an inner wall of the second flow port of the outer electrode are located outward of an inner wall of the fuel passage of the passage forming means in the radial direction and an axial direction of the outer electrode to such an extent as to reduce pressure loss of fuel, which flows from the inlet side part to the outlet side part of the fuel passage through the inner passage.
